(19) United States
(12) Patent Application Publication
(10) Pub. No.: US 2008/0176498 A1
(43) Pub. Date: Jul. 24, 2008

(54) GRINDING TOOLS AND APPARATUS FOR SECURING GRINDING TOOLS TO GRINDING MACHINES

(75) Inventors: Mark Rossi, Etobicoke (CA); Peter Calvin Renolds, Toronto (CA)

Correspondence Address: BERESKIN AND PARR, 40 KING STREET WEST, BOX 401, TORONTO, ON, M5H 3Y2, omitted

(73) Assignee: NUFINISH CORPORATION, Etobicoke (CA)

(21) Appl. No.: 12/015,547

(22) Filed: Jan. 17, 2008

Related U.S. Application Data
(60) Provisional application No. 60/885,438, filed on Jan. 18, 2007.

(51) Int. Cl. B24D 17/00; B23F 21/02; B24B 7/00; B24B 1/00

(52) U.S. Cl. 451/508; 451/548; 451/64; 451/59

(57) ABSTRACT

According to one example, a grinding plate for releasably mounting at least one grinding tool to a grinding machine, each grinding tool having a tool base with at least one grinding element mounted thereto, the grinding plate having least one pocket located proximate a periphery of the grinding plate, each pocket having an open end and being configured to releasably receive the at least one tool base via the open end, and a biasing element proximate the open end of the at least one pocket, the biasing element movable between an open position and a locked position and being biased to return to the locked position, wherein the tool base may be inserted and removed from the pocket when the biasing element is in the open position, and the pocket, tool base and biasing element are configured to restrict movement of the at least one tool base within the pocket when the tool base is received in the pocket and the biasing element is in the locked position.

### RELATED APPLICATIONS

This application claims priority from U.S. Provisional Application Ser. No. 60/885,438, entitled SPRING LOCK SYSTEM, filed on Jan. 18, 2007, the entire contents of which are hereby incorporated by reference for all purposes.

### FIELD

Disclosed are one or more apparatuses related to grinding machines, with common but by no means exclusive application to securing grinding tools to rotary and planetary grinding machines.

### BACKGROUND

For greater certainty, where reference is made herein to “rotary” or “rotating” movement or machines, it will be understood that the term is intended to include machines that exhibit rotary motion, planetary motion, and all other similar motions. Furthermore, the term “grinding” as used herein will be understood to include grinding, polishing, honing, lapping and otherwise mechanically working a hard surface, such as stone, concrete, terrazzo, and other materials.

Rotary grinding machines generally include one or more rotating heads, with one or more grinding tools attached to each head. For example, some grinding machines may include up to four rotating heads, with between three and six grinding tools mounted to each head.

The grinding tools (or grinding teeth) typically include one or more grinding elements, also known as grinding blocks, stones, or pads, which are made of a generally abrasive material and are configured to engage the surface to grind the surface as the one or more heads rotate.

The grinding elements may be releasably attached to the rotating heads by a tool base. Known systems for securing the tool bases to the rotating heads include the use of screws, bolts, hook and loop fasteners (e.g. Velcro™), and snap rings.

The grinding elements may be of many different types and configurations. Some grinding elements may be designed to wear out during grinding, and may need to be frequently changed to ensure that the desired grinding capabilities of the grinding tool are retained. Alternatively, the grinding elements may not be designed to wear out quickly. On some grinding machines, different grinding elements having different properties may be used to achieve different finishes. For example, a grinding tool having rough grinding elements may be used to achieve a rougher finish, while a different grinding tool with finer grinding elements may be used with the same grinding machine to achieve a smoother finisher.

Accordingly, it may be necessary to change the grinding tools that are used with a particular grinding machine, whether to replace a worn grinding tool or to change to a different tool for a different application. However, replacing the grinding tools on a rotating grinding machine can be a time consuming process, resulting in undesirable downtime.

### SUMMARY

The following summary is intended to introduce the reader to this specification, but not to define any specific claimed invention.

According to one example, a there is provided a grinding plate for releasably mounting at least one grinding tool to a grinding machine, each grinding tool having a tool base with at least one grinding element mounted thereto, the grinding plate comprising at least one pocket located proximate a periphery of the grinding plate, each pocket having an open end and being configured to releasably receive the at least one tool base via the open end, and a biasing element proximate the open end of the at least one pocket, the biasing element movable between an open position and a locked position and being biased to return to the locked position, wherein the tool base may be inserted and removed from the pocket when the biasing element is in the open position, and the pocket, tool base and biasing element are configured to restrict movement of the at least one tool base within the pocket when the tool base is received in the pocket and the biasing element is in the locked position.

In some examples, the grinding machine may be selected from the group consisting of a rotary grinder and a planetary grinder. The biasing element may comprise a leaf spring mounted to the grinding plate. The pocket may comprise a surface for receiving the tool base, and in the locked position the leaf spring extends upwardly past the surface of the pocket. The grinding plate may comprise a channel proximate the open end of the pocket and the leaf spring may be mounted in the channel.

In some examples, the grinding plate may further comprise a stop positioned proximate the periphery of the grinding plate and configured to engage with a front notch in the at least one tool base.

In some examples, each pocket may comprise sidewalls tapered at a first angle, each tool base may comprise side edges tapered at a second angle, and the first angle and second angle may be selected to provide an interference fit between the side edges and the sidewalls to restrict movement of the tool base upwardly away from the surface of the pocket.

In some examples, each pocket may comprise a first narrowing taper, each tool base may comprises a second narrowing taper, and the first narrowing taper and second narrowing taper may be selected to inhibit radial movement of the tool base in the direction of the periphery within the pocket beyond a predetermined distance.

In some examples, each pocket may have inner sidewall portions and outer sidewall portions spaced apart by recessed portions, and each tool base may have front side edges and rear side edges spaced apart by side notches, wherein the front side edges of the tool base are configured to be received in the recessed portions of the pocket as the tool base is inserted into the pocket.

In some examples, at least one of the tool base or pocket may include at least one ventilation hole for facilitating the removal of dust generated during grinding.

In some examples, at least one pocket may be provided as an insert that is removably attachable to the grinding plate.

In some examples, there is provided a grinding tool for use with the grinding plate.

According to another example, there is provided a grinding tool to be releasably mounting to a grinding plate, comprising a tool base, and at least one grinding element mounted to the tool base, wherein the grinding plate has at least one pocket configured to receive the tool base via an open end, and a biasing element proximate the open end of the pocket, the biasing element movable between an open position and a locked position and being biased to return to the locked position, and wherein the tool base may be inserted and removed from the pocket when the biasing element is in the open position, and the pocket, biasing element and tool base are configured to restrict movement of the tool base within the pocket when the tool base is received in the pocket and the biasing element is in the locked position.

In some examples, the grinding machine may be selected from the group consisting of a rotary grinder and a planetary grinder.

In some examples, the biasing element may comprise a leaf spring mounted to the grinding plate. The at least one pocket may comprise a surface for receiving the tool base, and the leaf spring extends upwardly past the surface of the pocket. The grinding plate may comprise a channel proximate the open end of the pocket and the leaf spring is mounted in the channel.

In some examples, the tool base comprises a front notch and each pocket comprises a stop positioned proximate a periphery of the grinding plate configured to engage the notch.

According to another example, there is provided a grinding machine comprising a grinding plate having at least one pocket located proximate a periphery of the grinding plate, each pocket having an open end, and at least one biasing element proximate the open end of the at least one pocket, the biasing element movable between an open position and a locked position and being biased to return to the locked position, at least one grinding tool, each having a tool base with at least one grinding element mounted thereto, wherein the at least one pocket is configured to releasably receive the at least one tool base via the open end, the tool base may be inserted and removed from the at least one pocket when the at least one biasing element is in the open position, and the pocket, tool base and biasing element are configured to restrict movement of the at least one tool base within the pocket when the tool base is received in the pocket and the at least one biasing element is in the locked position. The biasing element may comprise a leaf spring mounted to the grinding plate. The at least one pocket may comprises a surface for receiving the tool base, and the leaf spring extends upwardly past the surface of the pocket.

According to yet another example, there is provided a method of grinding a surface using a grinding machine, comprising providing the grinding machine having a grinding plate mounted thereto, receiving at least one tool base in at least one pocket of the grinding plate to secure at least one grinding element to the grinding plate, rotating the grinding plate and grinding the surface by using the grinding elements secured to the rotating grinding plate to engage the surface.

### BRIEF DESCRIPTION OF THE DRAWINGS

For a better understanding of the examples described herein, and to show more clearly how they may be carried into effect, reference will now be made, by way of example, to the accompanying drawings, in which:

FIG. 1 is a perspective view of a grinding plate for using with a grinding machine according to one example;

FIG. 2 is a perspective view of a portion of a grinding plate showing a grinding tool seated in a pocket;

FIG. 3 is a perspective view of a grinding tool;

FIG. 4 is a rear perspective view of the grinding tool of FIG. 3;

FIG. 5 is a bottom view of the grinding tool of FIG. 3;

FIG. 6 is an overhead view of the grinding tool of FIG. 3;

FIG. 7 is a front perspective view of the grinding tool of FIG. 3;

FIG. 8 is a close-up front view of a portion of the grinding tool of FIG. 3;

FIG. 9 is an overhead perspective view of a pocket;

FIG. 10 is a front perspective view of the pocket of FIG. 9;

FIG. 11 is a perspective view of the pocket of FIG. 9;

FIG. 12 is a cross-sectional end view of the pocket of FIG. 9;

FIG. 13 is a perspective view of a grinding tool received in a pocket;

FIG. 14 is an overhead view of the grinding tool and pocket of FIG. 13;

FIG. 15 is a front perspective view of the grinding tool and pocket of FIG. 13;

FIG. 16 is a close-up view of a portion of the grinding tool and pocket of FIG. 15;

FIG. 17 is a perspective view of a locking spring;

FIG. 18 is a overhead view of the locking spring of FIG. 17;

FIG. 19 is a cross-sectional view of the locking spring of FIG. 17 taken along line 19-19;

FIG. 20 is a bottom perspective view of a grinding plate having three pockets according to one example;

FIG. 21 is a top perspective view of the grinding plate of FIG. 20;

FIG. 22 is a bottom view of the grinding plate of FIG. 20;

FIG. 23 is a top view of the grinding plate of FIG. 20;

FIG. 24 is a bottom perspective view of a grinding plate having six pockets according to one example; and

FIG. 25 is a top perspective view of the grinding plate of FIG. 24.

### DETAILED DESCRIPTION

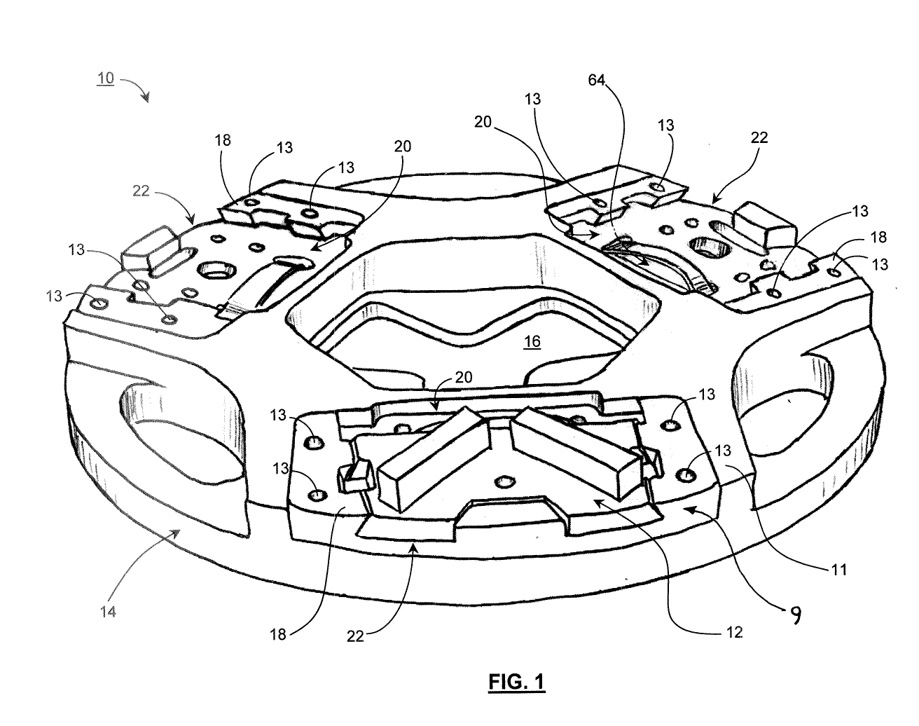

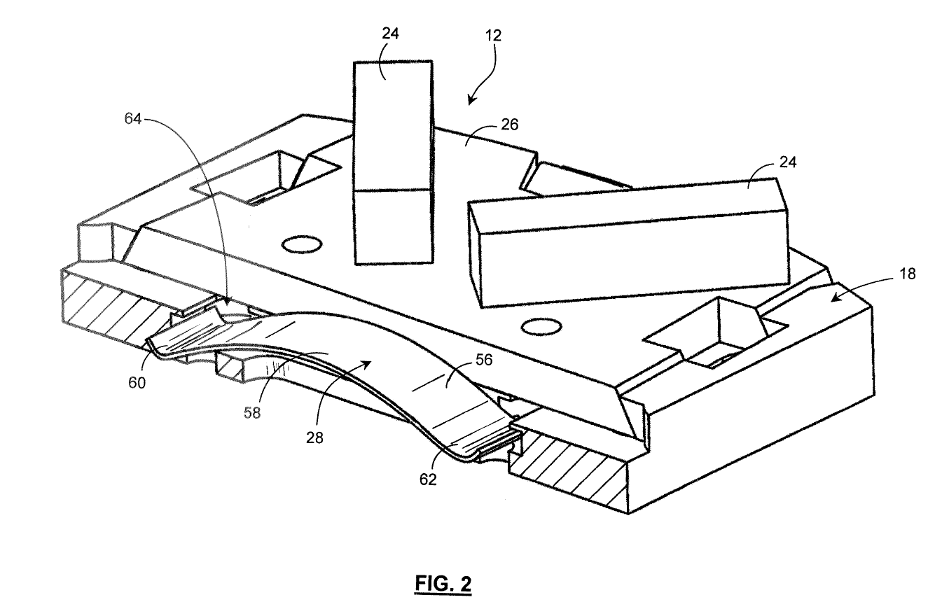

Referring generally to FIGS. 1 and 2, illustrated therein is a first example of a grinding plate 10 for securing one or more grinding tools 12 to a rotary grinding machine (not shown). The grinding plate 10 may be mounted to the rotary grinding machine by known methods, such as by bolts, screws, or other fasteners, or may be permanently affixed thereto. During grinding, the grinding plate 10 may be rotated or otherwise moved to effect grinding of the surface as described below.

The grinding plate 10 generally has an outer periphery or peripheral region 14 located outwardly from an inner region 16. The grinding plate 10 may be disc-shaped, as shown, although it will be appreciated that the grinding plate 10 could have other shapes and configurations.

As shown, the grinding plate 10 may include one or more pockets 18 positioned near the periphery or peripheral region 14 of the grinding plate 10, each pocket 18 being configured to receive at least one grinding tool 12. As shown, each pocket 18 generally has an open end 20 located near the inner region 16 of the grinding plate 10 and a closed end 22 located radially outwardly from the open end 20 near the peripheral region 14 of the grinding plate 10, and generally opposite the open end 20.

Each grinding tool 12 may include a tool base 26 having at least one grinding element 24, generally made of an abrasive material, mounted to the tool base 26. The tool base 26 can be received in one of the pockets 18 via the open end 20 so that the grinding tool 12 can be secured to the grinding plate 10.

As best shown in FIG. 2, the grinding plate 10 also includes a biasing element 28 (such as a locking spring or leaf spring 56) located near the open end 20 of the pocket 18. The biasing element 28 is generally movable between a locked position (as shown in FIG. 2) and an open position depressed towards the surface of the pocket 18 (as described in further detail below), and is biased to return to the locked position.

When the biasing element 28 is in the open position, the tool base 26 of the grinding tool 12 may be inserted and removed from the pocket 18 via the open end 20. When the tool base 26 has been received within the pocket 18 and the biasing element 28 is in the locked position, the pocket 18, tool base 26, and biasing element 28 generally cooperate to restrict movement of the tool base 26 within the pocket 18. The grinding tool 12 can therefore be secured to the grinding plate 10 so that the grinding elements 24 can grind a surface as the grinding plate 10 is rotated by the rotary grinding machine.

As shown, the biasing element 28 may comprise a leaf spring 56 that operates to lock the tool base 26 in the pocket 18, as will be described in greater detail below. It will be understood, however, that different biasing elements 26 could be used.

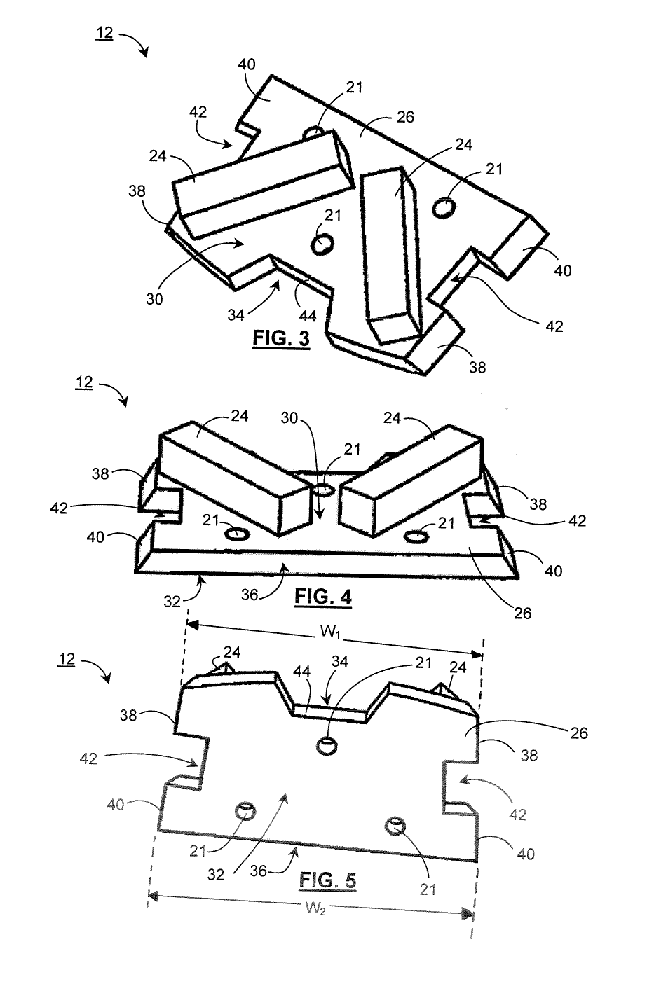

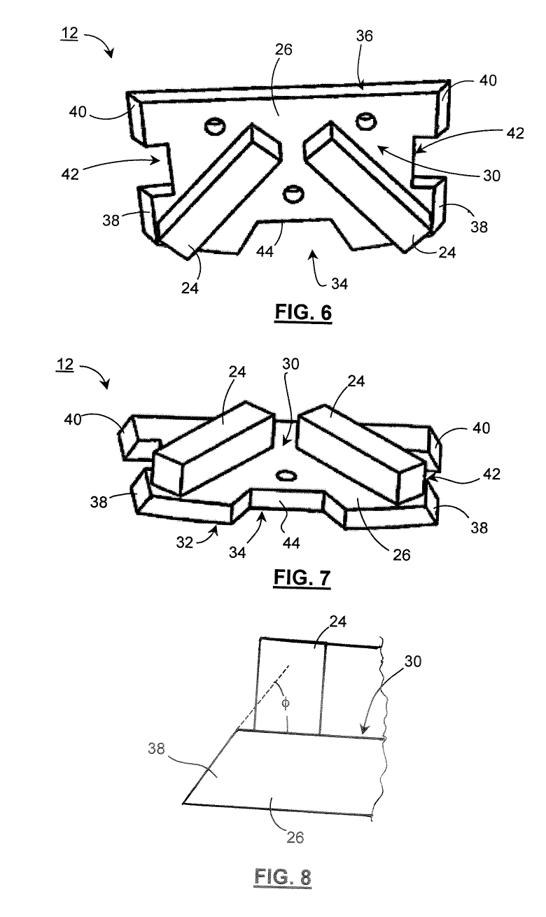

Turning now to FIGS. 3-7, the grinding tool 12 is shown in greater detail according to one example with two grinding elements 24 mounted to the tool base 26.

The grinding elements 24 can generally have any suitable configuration for grinding surfaces, and can be made of different suitable materials. For example, the grinding elements 24 may be diamond impregnated, polycrystalline diamond, tungsten carbide or any abrasive, cutting, scraping, grinding or polishing material generally usable to grind, cut, scrape, abrade, polish, lap or otherwise work stone, concrete or other generally planar surfaces.

The grinding elements 24 may vary greatly in size, shape, composition (e.g. type of abrasive material or matrix), and look and feel depending on the desired use. For example, the grinding elements 24 may include metal bonded segments brazed to a metal plate, and may also be resin-bonded with or without a plastic (or similar material) shell.

The grinding elements 24 may be rigidly secured to the tool base 26. In some examples, as shown in FIGS. 3-7, the tool base 26 may have a generally planar shape, with a top surface 30, a bottom surface 32 opposite the top surface 30, a leading portion 34, a trailing portion 36 opposite the leading portion 34, and opposite front side edges 38 or tabs and rear side edges 40 or tabs.

In some examples, as best shown in FIGS. 4 and 8, the front side edges 38 and rear side edges 40 of the tool base 26 may be tapered. For example, as best shown in FIG. 8, the front side edges 38 and rear side edges 40 may be inclined or tapered at an edge angle φ relative to the top surface 30 of the tool base 26. In some examples, the edge angle φ is an acute angle less than 90 degrees. As shown, the edge angle φ is approximately 60 degrees.

In some examples, the front side edges 38 and rear side edges 40 of the tool base 26 may form continuous opposing edges (not shown). In other examples, the front side edges 38 and rear side edges 40 may be separated by side notches 42, as will be discussed in greater detail below.

In some examples, tool base 26 may be made of any suitably rigid or resilient material, for example a metal (e.g. steel, aluminum, etc., whether cast, machined, etc.), a thermoset, or a thermoplastic.

In some examples, the tool base 26 can be shaped with a narrowing taper, as best shown in FIG. 5. As illustrated, the side edges 38, 40 are generally tapered wherein the width W₁ of the leading portion 34 is less that the width W₂ of the trailing portion 36. This narrowing taper can assist in securing the tool base 26 within the pocket 18 by providing an interference fit between the front side edges 38 and/or the rear side edges 40 of the tool base 26 with the sidewalls of the pocket 18, as detailed below.

In some examples, the narrowing taper may vary greatly. For example, the difference between W₁ and W₂ can be small, so that the narrowing taper is relatively minor. In other examples, the difference between W₁ and W₂ can be large so that the narrowing taper is relatively large.

The tool base 26 may also include a front notch 44 cut out from the leading portion 34 of the tool base 26.

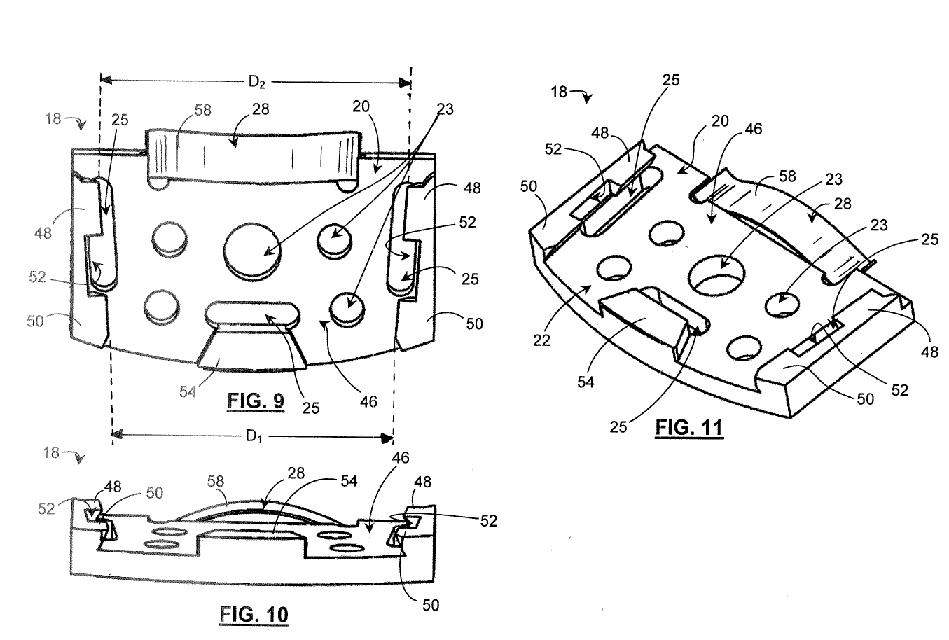

Turning now to FIGS. 9-12, the pocket 18 will be described in greater detail according to one example. The pocket 18 is generally configured to restrict the movement of the grinding tool 12 with respect to the grinding plate 10 when the tool base 26 has been received within the pocket 18. Accordingly, the grinding elements 24 of the grinding tool 12 can be used to grind a surface by rotating or otherwise moving the grinding plate 10 when the grinding tool 12 is attached thereto.

As shown, the pocket 18 may include an upper surface 46 configured to receive the bottom surface 32 of the tool base 26. The pocket 18 may further include inner sidewall portions 48 or tabs and outer sidewall portions 50 or tabs that extend upwardly away from and above the upper surface 46, around the edges of the upper surface. The inner sidewall portions 48 may be positioned near the open end 20 of the pocket (near the inner region 16 of the grinding plate 10), and outer sidewall portions 50 may be positioned near the closed end 22 of the pocket 18 (near the peripheral region 14 of the grinding plate).

In some examples, the inner sidewall portions 48 and outer sidewall portions 50 may form continuous opposing sidewalls along opposite edges of the upper surface 46 (not shown). In other examples, as best shown in FIGS. 9-11, the inner sidewall portions 48 and outer sidewall portions 50 may be separated by recessed portions 52.

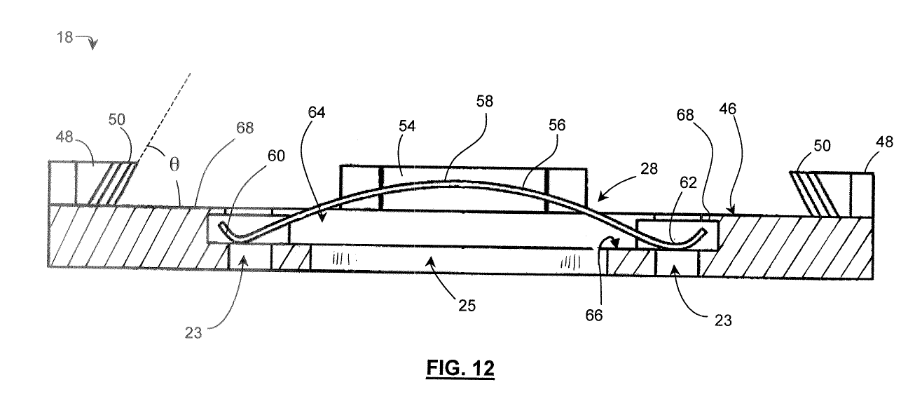

As shown in FIGS. 10 and 12, in some examples the inner sidewall portions 48 and outer sidewall portions 50 may be tapered. For example, the inner sidewall portions 48 and outer sidewall portions 50 may be tapered at a taper angle θ with respect to the upper surface 46. In some examples, the taper angle θ is less than 90 degrees. In the example shown, the taper angle θ is approximately 60 degrees.

The taper angle θ of the sidewall portions 48, 50 and the edge angle φ of the front and rear side edges 38, 40 of the tool base 26 may be selected so that the sidewall portions 48, 50 and the front and rear side edges 38, 40 interfere to restrict movement of the tool base 26 within the pocket 18 upwardly away from the upper surface 46 of the pocket 18 (when the tool base 26 has been received within the pocket 18). In some examples, the taper angle θ and the edge angle φ may be approximately equal.

In some examples, the pocket 18 can be shaped with a narrowing taper, as best shown in FIG. 9. For example, the sidewall portions 48, 50 may narrow between the open end 20 and the closed end 22 of the pocket 22, with the distance D₁ between the outer sidewalls 50 greater that the distance D₂ between of the inner sidewalls 48.

In some examples, the narrowing taper of the pocket 18 may correspond to the narrowing taper of the tool base 26, thus tending to secure the tool base 26 within the pocket 18 by providing an interference fit between the front side edges 38 and/or the rear side edges 40 of the tool base 26 with one or more of the sidewalls 48, 50 of the pocket 18. In this manner, the tool base 26 may be inhibited from moving radially outwards within the pocket 18 beyond a predetermined distance (for example, beyond the peripheral region 14). For example, this may be accomplished by selecting W₁, W₂, D₁ and D₂ such that D₂>W₂>D₁>W₁.

In some examples, the pocket 18 may include a stop 54 positioned near the peripheral region 14 of the grinding plate 10 (near the closed end 22 of the pocket 18). As shown, the stop 54 may comprise a protrusion that extends upwardly beyond the upper surface 46 of the pocket 18, generally intermediate the outer sidewalls 50. The stop 54 may be configured to engage with the front notch 44 on the tool base 26 to restrict movement of the tool base 26 within the pocket 18 radially outward beyond a predetermined distance (such as beyond the peripheral region 14 or beyond the closed end 22).

In some examples, during use of the grinding machine with the grinding tool 12 mounted in the grinding plate 10, centripetal forces acting radially outwardly on the tool base 26 may tend to result in the tool base 26 becoming wedged within the pocket 18, with the side edges 38, 40 engaged snuggly against the sidewalls 48, 50. This may make it difficult to remove the tool base 26 from the pocket 18 when it is desired, for example, to change the grinding tool 12. In some examples, the stop 54 and front notch 44 of the tool base 26 may be configured to inhibit the tool base 26 from becoming wedged within the pocket 18 by engaging the front notch 44 with the stop 54 before the side edges 38, 40 become snuggly seated against the sidewalls 48, 50.

In some examples, the tool base 26 and pocket 18 need not be sized to a tight tolerance between the side edges 38, 40 and sidewalls 48, 50, and generally the overall fit between the tool base 26 and the pocket 18 may be loose. This may be desirable to accommodate less than perfect manufacturing tolerances between the tool base 26 and pocket 18.

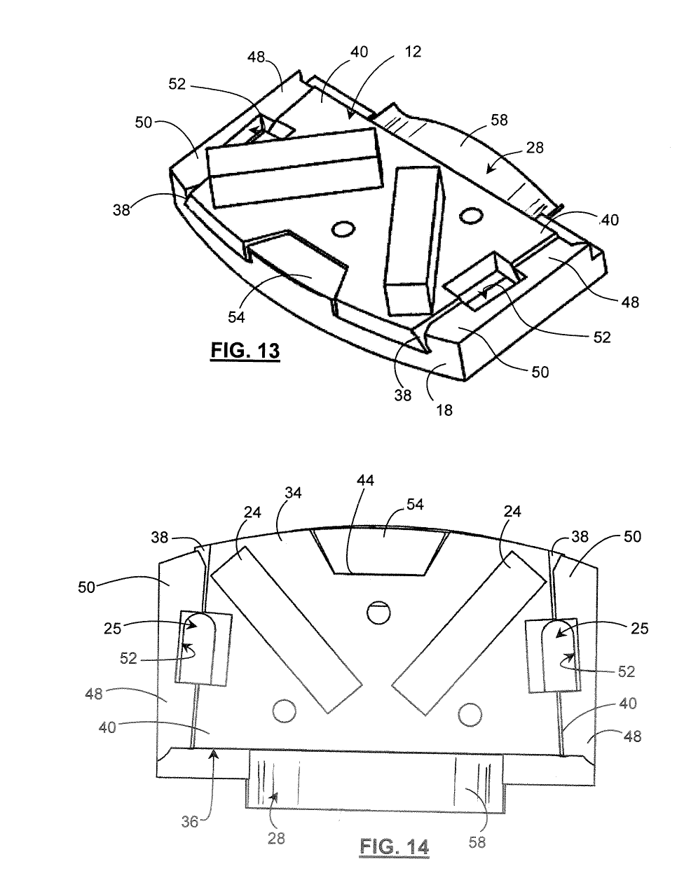

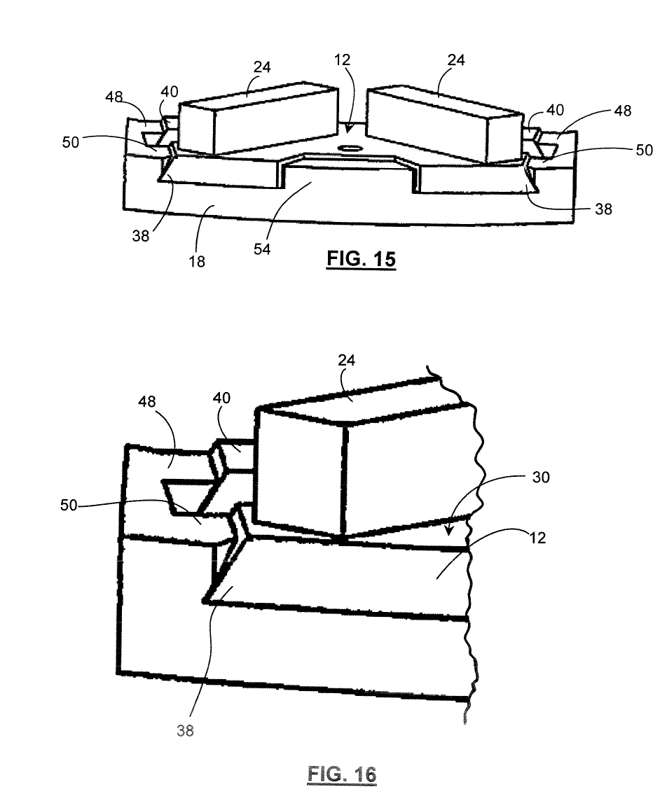

In some examples, with reference generally to FIGS. 13-16, the tool base 26 can be inserted into the pocket 18 of the grinding plate 10 by placing the tool base 26 above the pocket 18, intermediate the open end 20 and closed end 22 such that the front side edges 38 are above the recessed portions 52. As shown, the front side edges 38 may be configured to be received within the recessed portions 52, allowing the leading portion 34 of the tool base 26 to be inserted into the pocket 18 with the front side edges 38 received between the outer sidewalls 50 and the upper surface 46.

The lower surface 32 of the tool base 26 (near the open end 20) may be used to move the biasing element 28 from the locked position into the open position (such as by depressing the leaf spring 56). The tool base 26 may then be moved radially forward into the pocket 18 via the open end 20, with the rear side edges 40 received between the inner sidewalls 48 and the upper surface 46, until the tool base 26 is received within the pocket 18.

In some examples, the biasing element 28 could be depressed by hand as the tool base 26 is inserted into the pocket 18.

When the tool base 26 is fully received within the pocket 18, as best shown in FIGS. 13 and 14, the lower surface 32 of the tool base 26 will no longer be depressing the biasing element 28, and thus the biasing element 28 may return to its resting state (e.g. the locked position). Once received in the pocket 18, the bottom surface 32 of the tool base 26 generally engages the upper surface 46 of the pocket 18.

In the example shown, the tool base 26 may be restricted from moving radially inwardly, as the trailing portion 36 of the tool base 26 will tend to engage the biasing element 28 (such as on an edge of the leaf spring 56). Movement of the tool base 26 upwardly away from the upper surface 46 (i.e. normal to the upper surface 46) may be restricted by the cooperation or interference of the tapered side edges 38, 40 and the tapered sidewall portions 40, 42.

Similarly, movement of the tool base 26 within the pocket 18 radially outwardly (i.e. along an axis between the open end 20 and the closed end 22 from the inner portion 16 to the peripheral region 14 of the grinding plate 10) may be restricted by one or more of the narrowing taper of the tool base 26 and the pocket 18, and the stop 54 engaging the front notch 44. It may not be necessary to use both the stop 54 and the narrowing taper to inhibit radially movement of the tool base 26 outwardly but the use of both may be desirable in some applications.

Furthermore, movement of the tool base 26 within the pocket 18 transversely (i.e. perpendicular to the radial direction) may be restricted by the widths W₁, W₂, of the tool base 26 being selected to cooperate with the distances D₁, D₂ between the sidewalls 48, 50 of the pocket 18.

Thus, the tool base 26 may be restricted from being removed from the pocket 18, with the various elements of the pocket 18, tool base 26 and the biasing element 28 tending to ensure that the tool base 26 is positioned within the pocket 18 such that the grinding elements 24 of the grinding tools 12 are in desired orientations.

For example, the tool base 26 may be configured to be received within the pocket 18 such that the grinding elements 24 reach to the peripheral region 14 of the grinding plate 10, providing a desired amount of cutting, grinding or polishing width, without tending to damage the exterior housing of the grinding machine or any dust control items that may be attached thereto.

When it is desired to change the grinding tool 12, for example if the grinding elements 24 have become worn or if a different grinding tool 12 having different grinding elements 24 is desired to be used, the tool base 26 can be removed from the pocket 18 by moving the biasing element 28 into the open position (such as by depressing the leaf spring 56), and removing the tool base 26 via the open end 20 of the pocket. In some examples, the biasing element 28 is configured so that it may be moved into the open position by hand without the use of any additional tools.

In some examples, alternative configurations of the pocket 18 and tool base 26 may be provided to restrict the movement of the tool base 26 within the pocket 18. For example, cooperating grooves may be provided between the pocket 18 and the tool base 26, for example a tongue-in-groove system provided in one or more of the sidewalls 48, 50, side edges 38, 40, upper surface 46 and bottom surface 32 to inhibit movement of the tool base 26 in one or more directions. In some examples, one or more magnets may be used to secure the tool base 26 within the pocket 18.

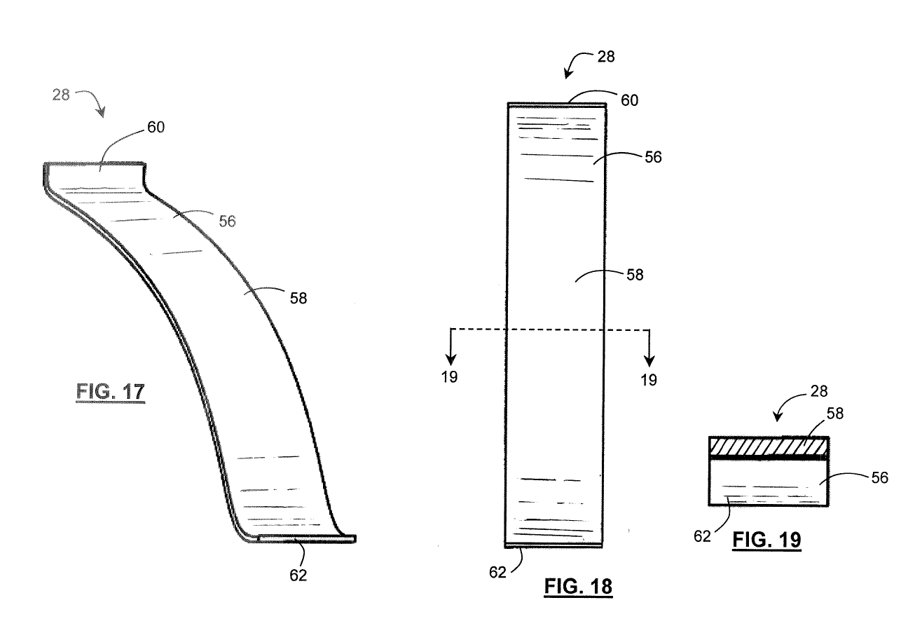

Turning now to FIGS. 17-19, further details of one example of the biasing element 28 are provided. As shown, the biasing element 28 comprises a leaf spring 56 having a generally planar elongate shape. The leaf spring 56 includes a curved or arched central portion 58, with an opposite first end 60 and second end 62. The first and second end 60, 62 are curved upward in a direction opposite the curve of the central portion 58.

As best shown in FIGS. 2 and 12, the leaf spring 56 may be received in a channel 64 provided in the grinding plate 10 proximate the open end 20 of the pocket 18. The channel 64 may be positioned so that the leaf spring 56 may be used to selectively obstruct the open end 20 of the pocket 18 to restrain the tool base 26 therein.

The channel 64 includes an abutting surface 66 on which the leaf spring 56 rests, and protruding flanges 68 positioned at opposite ends of the channel 64 above the abutting surface 66. In the locking position, the first and second ends 60, 62 of the leaf spring 56 rest on the abutting surface 66, and the central portion 58 extends upwardly past the upper surface 46 of the pocket 18, thus obstructing the open end 20.

To move the leaf spring 56 into the open position (to allow the tool base 26 to be inserted or removed from the pocket 18), the central portion 58 of the leaf spring 56 may be depressed, causing the leaf spring 56 to deflect and facilitating access to the pocket 18 via the open end. As the central portion 58 is depressed, the first and second ends 60, 62 of the leaf spring 56 will tend to move outwards and upwards and engage with the protruding flanges 68 (tending to keep the leaf spring 56 securely within the channel 64).

In some examples, the leaf spring 56 may be removed from the channel 64 by longitudinally compressing the leaf spring 56 (i.e. by moving the first end 60 towards the second end 62).

As shown, when the tool base 26 is received in the pocket 18 and the leaf spring 56 is in the locked position, the trailing portion 36 of the tool base 26 will tend to engage an edge of the leaf spring 56. The leaf spring 56 tends to be highly resistant to deflection when engaged on its edges, and thus will tend to resist radially inward movement of the tool base 26.

In other examples, the leaf spring 56 may be mounted in other configurations with respect to the tool base 26. For example, the leaf spring 56 may be mounted such that the trailing portion 36 of the tool base 26 engages the flat surface of the central portion 58 of the leaf spring 56, such that the leaf spring 56 would tend to place a constant pressure on the tool base 26.

Additionally, other forms of biasing elements 28 may be used. For example, different springs, such as coil or pop-up style springs could be used and mounted within the upper surface 46 of the pocket 18 such that when the tool base 26 is received within the pocket 18, the coil spring would pop up into a recess in the bottom surface 32 of the tool base 26 to secure the tool base 26 in a desired location. The coil or pop-up spring could be depressed to remove the tool base 26, such as by hand or with the use of a tool. In another example, a coil spring could be mounted near the open end 20 of the pocket 18 and be configured to apply a generally constant pressure on the tool base 26 when the tool base 26 is received within the pocket 18. Such a coil spring could be depressed to remove the tool base 26.

Many different combinations of springs and other biasing elements provided at different locations may be used, and in some examples, multiple biasing elements could be used to secure one tool base 26 within a single pocket 18.

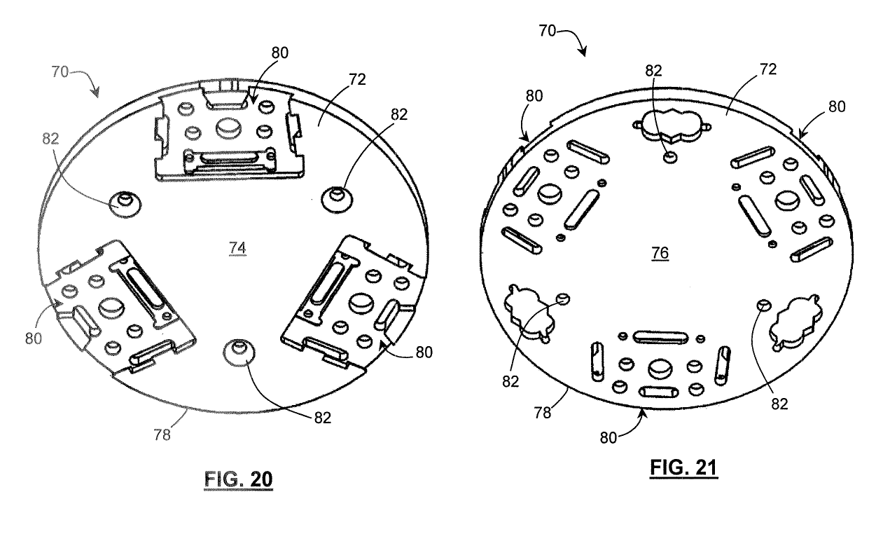

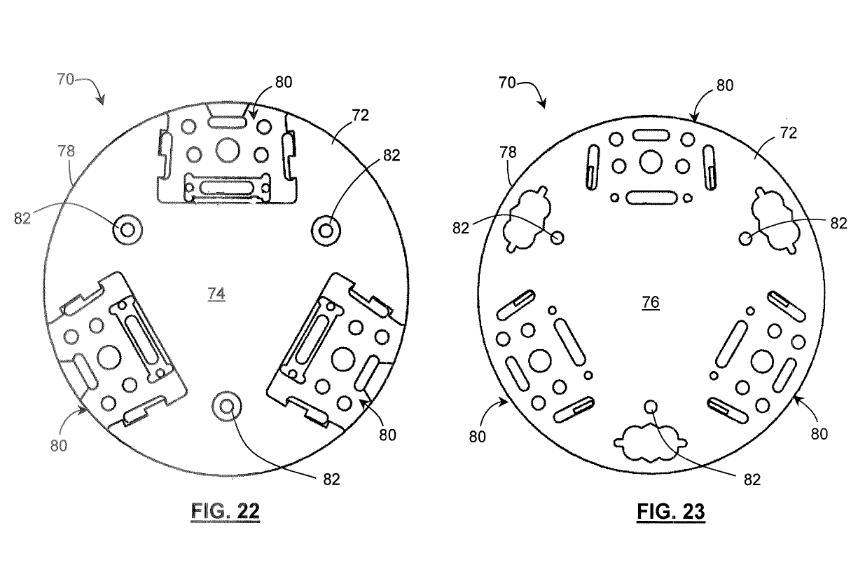

Turning now to FIGS. 20-23, a grinding plate 70 according to another example is shown. Grinding plate 70 includes a generally disc-shaped portion 72 having a bottom surface 74, a top surface 76, and a peripheral region 78.

As shown, three pockets 80 are shown provided in the peripheral region 78 of the grinding plate 70. The pockets 80 are substantially similar to the pockets 18 described above, and are equally spaced around the peripheral region 78. As shown, the pockets 80 have been formed integrally within the grinding plate 70, such as by machining metal away from the grinding plate to create the pockets 80. The pockets 80 may be configured to receive grinding tools such as grinding tools 12 described above.

In some examples, the grinding plate 70 may be permanently mounted to a grinding machine (not shown). In other examples, the grinding plate 70 may be removably mounted to a grinding machine, such as by bolts engaging with mounting holes 82.

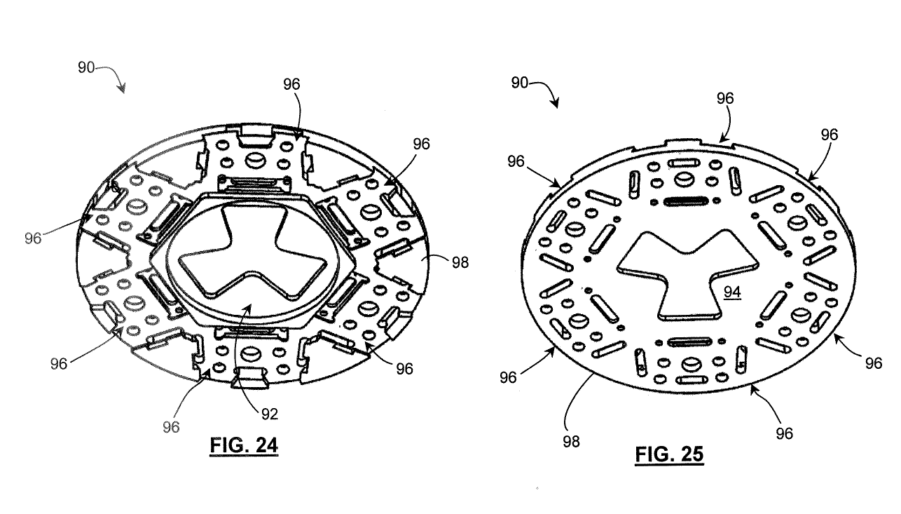

Turning now to FIGS. 24-25, a grinding plate 90 according to another example is shown. Grinding plate 90 is generally disc-shaped, having a bottom surface 92, a top surface 94, and six pockets 96 spaced around a peripheral region 98 of the grinding plate 90. Pockets 96 may be substantially similar to the pockets 18 described above, and may be configured for receiving grinding tools 12.

In some examples the grinding plates 10, 70 and 90 and grinding tools 12 may include one or more ventilation holes or dust channels. For example, as shown in FIGS. 3-7, the grinding tools 12 may include ventilation holes 21 provided therein. Similarly, the pockets 18 may include ventilation holes 23 or ventilation channels 25. The ventilation holes 21, 23 and ventilation channels 25, and channels 64 tend to prevent a build up of dust and other ground material generated during grinding that may otherwise tend to interfere with the movement of the biasing element 28, or build up between the tool base 26 and the pocket 18 that may tend to interfere with insertion and removal of the tool base 26.

In some examples, as shown with reference to grinding plates 70 and 90, the pockets may be formed integrally with the grinding plates 70, 90. In other examples, the pockets 18 may be provided as inserts that can be removable secured to the grinding plates. For example, as shown in FIG. 1, the pockets 18 may be provided as inserts 9 that are releasably securable to a housing portion 11 of the grinding plate 10, such as by the use of bolts or other fasteners coupled to the housing portion 11 via mounting holes 13.

In some examples, a method of using a grinding machine to grind a surface is provided. The method may include providing a grinding machine (not shown) having the grinding plate 10 secured thereto. The method may further include mounting at least one grinding tool 12 to the grinding plate 10 by moving the biasing element 28 into the open position, receiving at least one tool base 26 within at least one pocket 18 on the grinding plate, and the biasing element 28 moving to the locking position.

The method may further include rotating the grinding plate 10, such as by the action of an electric or gas powered motor secured to the grinding machine.

The method may further include grinding the surface by using the grinding elements secured to the rotating grinding plate to engage the surface. In some examples, the method may further include removing dust and other particulate matter generated by the grinding, such as via one or more of the ventilation holes 21, 23 and channels 25, to facilitate the grinding of the surface.

The method may further include moving the biasing element 28 into the open position, removing the tool base 26 from the pocket 18, and restoring the biasing element 28 to the locked position.

What has been described is merely illustrative of the application of some embodiments of the invention. Other systems, apparatus and methods can be implemented by those skilled in the art without departing from the spirit and scope of the invention, which is defined by the following claims.

1. A grinding plate for releasably mounting at least one grinding tool to a grinding machine, each grinding tool having a tool base with at least one grinding element mounted thereto, the grinding plate comprising:
a) at least one pocket located proximate a periphery of the grinding plate, each pocket having an open end and being configured to releasably receive the at least one tool base via the open end; and
b) a biasing element proximate the open end of the at least one pocket, the biasing element movable between an open position and a locked position and being biased to return to the locked position;
c) wherein the tool base may be inserted and removed from the pocket when the biasing element is in the open position, and the pocket, tool base and biasing element are configured to restrict movement of the at least one tool base within the pocket when the tool base is received in the pocket and the biasing element is in the locked position.

2. The grinding plate of claim 1, wherein the grinding machine is selected from the group consisting of a rotary grinder and a planetary grinder.

3. The grinding plate of claim 2, wherein the biasing element comprises a leaf spring mounted to the grinding plate.

4. The grinding plate of claim 3, wherein the pocket comprises a surface for receiving the tool base, and in the locked position the leaf spring extends upwardly past the surface of the pocket.

5. The grinding plate of claim 4, wherein the grinding plate comprises a channel proximate the open end of the pocket and the leaf spring is mounted in the channel.

6. The grinding plate of claim 2, further comprising a stop positioned proximate the periphery of the grinding plate and configured to engage with a front notch in the at least one tool base.

7. The grinding plate of claim 4, wherein:
a) each pocket comprises sidewalls tapered at a first angle;
b) each tool base comprises side edges tapered at a second angle; and
c) wherein the first angle and second angle are selected to provide an interference fit between the side edges and the sidewalls to restrict movement of the tool base upwardly from away from the surface of the pocket.

8. The grinding plate of claim 2, wherein:
a) each pocket comprises a first narrowing taper;
b) each tool base comprises a second narrowing taper;
c) and the first narrowing taper and second narrowing taper are selected to inhibit radial movement of the tool base in the direction of the periphery within the pocket beyond a predetermined distance.

9. The grinding plate of claim 2, wherein:
a) each pocket has inner sidewall portions and outer sidewall portions spaced apart by recessed portions; and
b) each tool base has front side edges and rear side edges spaced apart by side notches;
c) wherein the front side edges of the tool base are configured to be received in the recessed portions of the pocket as the tool base is inserted into the pocket.

10. The grinding plate of claim 2, wherein at least one of the tool base or pocket include at least one ventilation hole for facilitating the removal of dust generated during grinding.

11. The grinding plate of claim 2, wherein the at least one pocket is provided as an insert that is removably attachable to the grinding plate.

12. A grinding tool for use with the grinding plate of claim 2.

13. A grinding tool to be releasably mounting to a grinding plate, comprising:
a) a tool base; and
b) at least one grinding element mounted to the tool base;
c) wherein the grinding plate has at least one pocket configured to receive the tool base via an open end, and a biasing element proximate the open end of the pocket, the biasing element movable between an open position and a locked position and being biased to return to the locked position; and
d) wherein the tool base may be inserted and removed from the pocket when the biasing element is in the open position, and the pocket, biasing element and tool base are configured to restrict movement of the tool base within the pocket when the tool base is received in the pocket and the biasing element is in the locked position.

14. The grinding tool of claim 13 wherein the grinding machine is selected from the group consisting of a rotary grinder and a planetary grinder.

15. The grinding tool of claim 14, wherein the tool base comprises a front notch and each pocket comprises a stop positioned proximate a periphery of the grinding plate and configured to engage the notch.

16. A grinding machine, comprising
a) a grinding plate having at least one pocket located proximate a periphery of the grinding plate, each pocket having an open end, and at least one biasing element proximate the open end of the at least one pocket, the biasing element movable between an open position and a locked position and being biased to return to the locked position; and
b) at least one grinding tool, each having a tool base with at least one grinding element mounted thereto;
c) wherein the at least one pocket is configured to releasably receive the at least one tool base via the open end, the tool base may be inserted and removed from the at least one pocket when the at least one biasing element is in the open position, and the pocket and biasing element are configured to restrict movement of the at least one tool base within the pocket when the tool base is received in the pocket and the at least one biasing element is in the locked position.

17. The grinding machine of claim 16, wherein the biasing element comprises a leaf spring mounted to the grinding plate.

18. The grinding machine of claim 17, wherein the at least one pocket comprises a surface for receiving the tool base, and the leaf spring extends upwardly past the surface of the pocket.

19. A method of grinding a surface using the grinding machine of claim 17, comprising:
a) providing the grinding machine;
b) receiving the at least one tool base in the at least one pocket to secure the at least one grinding element to the grinding plate;
c) rotating the grinding plate; and
d) grinding the surface by using the grinding elements secured to the rotating grinding plate to engage the surface.
